(19) United States
(12) Patent Application Publication
(10) Pub. No.: US 2022/0396443 A1
(43) Pub. Date: Dec. 15, 2022

(54) MEDIUM SUPPLY DEVICE AND RECORDING DEVICE

(71) Applicant: SEIKO EPSON CORPORATION, Tokyo (JP)

(72) Inventors: Takanori UMEDA, Shiojiri-shi (JP); Keisuke YAMAYA, Shiojiri-shi (JP)

(21) Appl. No.: 17/806,704

(22) Filed: Jun. 13, 2022

(30) Foreign Application Priority Data
Jun. 14, 2021 (JP) 2021-098580

(51) Int. Cl. B65H 5/06; B65H 27/00

(52) U.S. Cl. CPC B65H 5/068; B65H 27/00; B65H 2801/06; B65H 2404/1116; B65H 2404/1321

(57) ABSTRACT

A medium supply device is provided that includes a single sheet paper accommodating unit at which media are stacked and placed, and a feeding roller configured to feed the media by rotating in contact with a top surface of the placed media. The feeding roller includes a contact portion configured to contact the single sheet paper and a non-contact portion configured to not contact the single sheet paper in a rotational direction, and a plurality of the contact portions and the non-contact portions are provided in a first direction that is an extending direction of a rotation axis of the feeding roller, and the contact portions adjacent to each other in the first direction are out of phase in the rotational direction.

The present application is based on, and claims priority from JP Application Serial Number 2021-098580, filed Jun. 14, 2021, the disclosure of which is hereby incorporated by reference herein in its entirety.

### BACKGROUND

### 1. Technical Field

The present disclosure relates to a medium supply device and a recording device.

### 2. Related Art

A medium supply device including a feeding roller that feeds media, such as stacked sheets of paper, one by one is known. For example, JP2005-194023 A discloses an automatic document transporting device including a pickup roller for taking out paper and a separate roller for separating the topmost paper and feeding the paper out to a transport path.

However, the device described in JP2005-194023 A has a problem that roller marks of the pickup roller are often caused on the medium. Specifically, the above-mentioned device adopts, as a feeding roller, a cylindrical pickup roller having a substantially columnar shape. In the case of such a cylindrical pickup roller, the medium tends to be pressed strongly at both end positions, in the extending direction of the rotational axis, of the pickup roller.

The pickup roller feeds the first sheet of paper, which is the top paper the pickup roller contacts while pressing the stacked sheets of paper. At this time, the first paper and the second paper under the first paper are pressed by the pickup roller, and in particular, the end position is strongly rubbed. The first sheet of paper is transported while being pressed, while the second sheet of paper remains without being transported. Therefore, roller marks are often caused at the end positions where the second sheet of paper is pressed.

Therefore, there is a demand for a medium supply device that suppresses the occurrence of roller marks by the feeding roller.

### SUMMARY

A medium supply device is provided that includes a loading unit at which media are stacked and placed, and a feeding roller configured to feed the media by rotating in contact with a top surface of the placed media. The feeding roller includes a contact portion configured to contact the media and a non-contact portion configured to not contact the media in a rotational direction, and a plurality of the contact portions and the non-contact portions are provided in a first direction that is an extending direction of a rotation axis of the feeding roller, and the contact portions adjacent to each other in the first direction are out of phase in the rotational direction.

A medium supply device is provided that includes a recording unit configured to perform recording on a medium, a medium supply unit configured supply the medium toward the recording unit, a transport path configured to transport the medium from the medium supply unit to the recording uni. The medium supply unit includes a loading unit at which the medium is placed, and a feeding roller configured to feed the medium by rotating in contact with a top surface of the loaded medium. The feeding roller includes a contact portion configured to contact the medium and a non-contact portion configured to not contact the medium in a rotational direction, and a plurality of the contact portions and the non-contact portions are provided in a first direction that is an extending direction of the rotation axis of the feeding roller, and the contact portions adjacent to each other in the first direction are out of phase in the rotational direction.

### BRIEF DESCRIPTION OF THE DRAWINGS

FIG. 1 is a perspective view illustrating an exterior of a recording device including a medium supply device according to an embodiment.

FIG. 2 is a perspective view illustrating an exterior of a recording device with the front part open.

FIG. 3 is a schematic cross-sectional view illustrating an internal configuration of the medium supply device and the recording device.

FIG. 4 is a perspective view illustrating an exterior of a housing including the medium supply device and a transport path.

FIG. 5 is a perspective view illustrating an exterior of the housing in a state in which the second cover is released.

FIG. 6 is an enlarged view illustrating an internal configuration exposed by opening the second cover.

FIG. 7 is a perspective view illustrating a configuration of a second roller unit.

FIG. 8 is a cross-sectional view taken along the YZ plane including the line A-A in FIG. 7.

FIG. 9 is an enlarged view illustrating an internal configuration exposed by opening a first cover.

FIG. 10 is a perspective view illustrating a configuration of a first roller unit.

FIG. 11 is a perspective view illustrating an exterior of a feeding roller.

FIG. 12 is a side view illustrating an exterior of the feeding roller.

FIG. 13 is a side view illustrating another form of a divided feeding roller.

FIG. 14 is a top view illustrating an exterior of the feeding roller.

FIG. 15 is a schematic view illustrating an arrangement of a feeding roller and single sheet paper placed at a single sheet paper accommodating unit.

FIG. 16 is a perspective view illustrating the arrangement of a paper return lever and a second transport path member.

FIG. 17 is a schematic view illustrating a state of a paper return lever when the tray is set.

FIG. 18 is a schematic view illustrating a state of a paper return lever when the tray is being drawn.

FIG. 19 is a flowchart illustrating a retraction function of a feeding roller.

FIG. 20 is a schematic side view illustrating an arrangement when the feeding roller is retracted.

FIG. 21 is a schematic side view illustrating an arrangement at the time of feeding by the feeding roller.

FIG. 22 is a schematic view illustrating an arrangement of an operation unit.

FIG. 23 is a schematic view illustrating operation related to attachment and detachment of the first roller unit.

FIG. 24 is an enlarged view illustrating a state in which the first roller unit is removed.

### DESCRIPTION OF EXEMPLARY EMBODIMENTS

In the present embodiment, a medium supply device for supplying single sheet paper is illustrated. The medium feeding device is included in an ink-jet type printer, which is a recording device that performs recording by discharging ink to a medium which is roll paper and single sheet paper, for example. Hereinafter, the configuration of the medium supply device 100 and the recording device 11 including the medium supply device 100 according to the present embodiment will be described with reference to the drawings.

In each of the drawings, XYZ axises are provided, as necessary, as coordinate axises orthogonal to each other, and a direction indicated by each arrow is referred to as a + direction, and a direction opposite to the + direction is referred to as a − direction. The Y-axis is along the front-rear rear direction of the recording device 11, and the +Y direction of the recording device 11 corresponds to frontward. The X-axis is along the left-right direction of the recording device 11, and the +X direction of the recording device 11 corresponds to rightward. Also, the +X direction and the −X direction, which are the directions along the X-axis, may be collectively referred to as the X direction. The Z-axis is a virtual axis along the vertical direction, and the +Z direction of the recording device 11 corresponds to downward.

### Recording Device

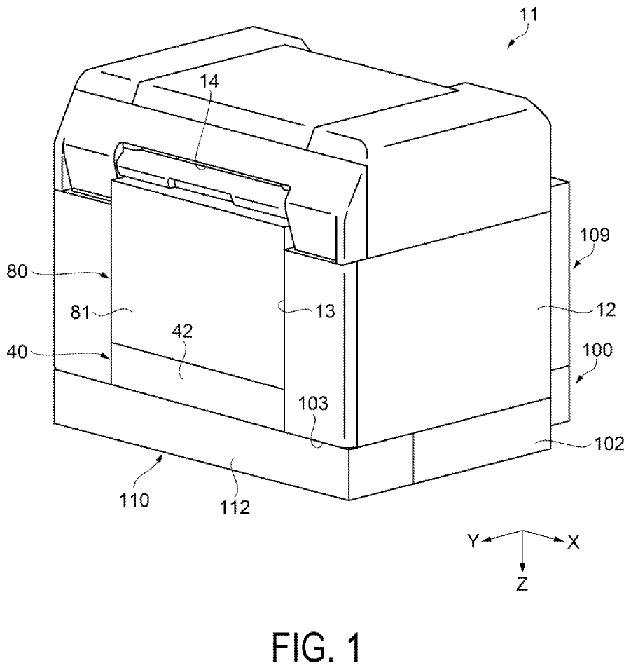

As illustrated in FIGS. 1 to 3, the recording device 11 includes a medium supply device 100 as a medium supply unit, a recording unit 20, and a transport path 109. The medium supply device 100 supplies single sheet paper SP that is the medium toward the recording unit 20. The transport path 109 transports single sheet paper SP from the medium supply device 100 to the recording unit 20. The recording unit 20 performs recording on both the roll paper RP and the single sheet paper SP.

Note that the single sheet paper SP is an example of the medium of the present disclosure, but in the following description, the roll paper RP may also be referred to as a medium. The single sheet paper SP and the roll paper RP are not limited to paper, and may be, for example, a coating layer provided on the surface of the paper or a resin film.

The medium supply device 100 includes a single sheet paper accommodating unit 110 as a loading unit. single sheet paper SP is stacked and placed in a single sheet paper accommodating unit 110. The medium supply device 100 is located below the recording device 11.

The recording device 11 includes a cuboid housing 12 and a body frame 16 that supports each portion of the recording device 11. A roll paper accommodating unit 40 and a recording unit 20 are disposed inside the housing 12. A roll paper RP is accommodated in the roll paper accommodating unit 40. The roll paper accommodating unit 40 is located below the recording unit 20. Here, the directions away from and toward the roll paper accommodating unit 40 or the single sheet paper accommodating unit 110 may be referred to as downstream and upstream respectively.

The recording unit 20 includes a head 22 including a nozzle 23 that dispenses ink toward the medium M, a carriage 21 on which the head 22 is mounted, and a guide rail 24 located along the X axis. The recording unit 20 includes a movement mechanism that reciprocates the carriage 21 along the guide rail 24.

A support portion 25 supporting the medium M is provided facing the head 22. The head 22 dispenses ink while reciprocating together with the carriage 21 in X direction corresponding to the width direction of the medium, thereby performing recording on the medium supported by the support portion 25. In the present embodiment, a serial head system, in which the head 22 reciprocates in the paper width direction, is given as an example of the recording unit 20, but the recording unit 20 is not limited thereto. The recording unit 20 may be a line head system in which the head extends in the paper width direction and is fixedly arranged.

The upper part in the housing 12 is provided with a medium transport path 30 on which the medium is transported, and a cutting unit 27 capable of cutting the medium on which recording was performed by the recording unit 20. The medium transporting path 30 includes a supply path 30a and an inversion path 30b provided upstream of the support portion 25 and a discharge path 30c provided downstream of the support portion 25. The supply path 30a includes a roll paper supply path 30R on which the roll paper RP is supplied, and a single sheet paper supply path 30S on which single sheet paper SP is supplied.

The supply path 30a is a path that couples the roll paper supply path 30R to the support portion 25. A roll paper merging point P2 is provided upstream of the supply path 30a where the supply path 30a merges with the roll paper supply path 30R. A branch point P1 is provided downstream of the supply path 30a for the case in which the medium is transported from downstream to upstream. The supply path 30a branches out to the inversion path 30b at the branch point P1. The reverse path 30b is a path that couples the branch point P1 to the roll paper merging point P2. A single sheet paper merging point P3 where the supply path 30a merges with the single sheet paper supply path 30S is provided between the roll paper merging point P2 and the branch point P1 in the supply path 30a.

An discharge port 14 for discharging the medium on which recording was performed is provided at the front surface of the housing 12. Note that the front surface of the housing 12 is a surface facing the front part of the housing 12. The discharge path 30c is a path coupling the support portion 25 to the discharge port 14. A cutting unit 27 that cuts the medium on which recording was performed by the recording unit 20 is provided midway on the discharge path 30c.

The cutting unit 27 includes a movable blade 28 and a fixed blade 29. The movable blade 28 reciprocates in a direction along the X-axis direction corresponding to the width direction of the medium. The fixed blade 29 extends in the paper width direction and is fixed. The movable blade 28 is provided above the discharge path 30c and the fixed blade 29 is provided below the discharge path 30c. The movable blade 28 moves in the paper width direction in contact with the fixed blade 29, and thus, the roll paper RP unwound from the rolled state, or the margin part, for example, are cut. A cutting waste accommodating unit 80 is disposed below the cutting unit 27. The cutting waste accommodating unit 80 accommodates cutting waste generated by cutting the medium by the cutting unit 27.

The medium transport path 30 is provided with a transport unit 31 that transports the medium supplied to the medium transport path 30. The transport unit 31 includes, on the supply path 30a, an intermediate roller 32, a plurality of driven rollers 33 provided at the outer periphery of the intermediate roller 32, and the upstream transport roller pair 34 in this order from upstream. The driven roller 33 is rotatably provided and is driven to rotate with the medium disposed between the driven roller 33 and the intermediate roller 32. The transport unit 31 includes, on the discharge path 30c, a downstream transport roller pair 35, a first roller pair 36, and a second roller pair 37 in this order from upstream. The first roller pair 36 is located upstream of the cutting unit 27, and the second roller pair 37 is located downstream of the cutting unit 27.

The intermediate roller 32, the driven roller 33, the upstream transport roller pair 34, the downstream transport roller pair 35, the first roller pair 36, and the second roller pair 37 transport the medium by rotating in the state of sandwiching the medium. The transport unit 31 transports the medium from upstream to downstream by being driven into forward rotation. The transport unit 31 transports the medium from downstream to upstream by being driven into reverse rotate.

The recording device 11 drives the transport unit 31 into forward rotation to transport the medium from upstream to downstream, while discharging ink from the recording unit 20 to the medium located at the support portion 25, thereby performing recording on the first surface of the medium. The recording device 11 can also perform recording on the second surface, which is the back surface of the first surface of the medium.

The recording device 11 transports, after recording on the first surface, the medium from downstream to upstream by rotating the transport unit 31 into reverse rotation. The medium reaches from the branch point P1 to upstream of the supply path 30a via the inversion path 30b. The recording device 11 again drives the transport unit 31 into forward rotation so that the medium makes one rotation around the outer periphery of the intermediate roller 32, thereby inverting the front and back sides of the medium. The recording device 11 transports the medium from upstream to downstream, while discharging ink from the recording unit 20 to the medium located at the support portion 25, thereby performing recording on the second surface of the medium. Thus, recording is performed on both sides of the medium. When the medium is the roll paper RP unwound from the rolled state, the medium is, after recording is performed on the front surface thereof, cut into single sheet paper by the cutting unit 27, and then recording is performed on the back surface.

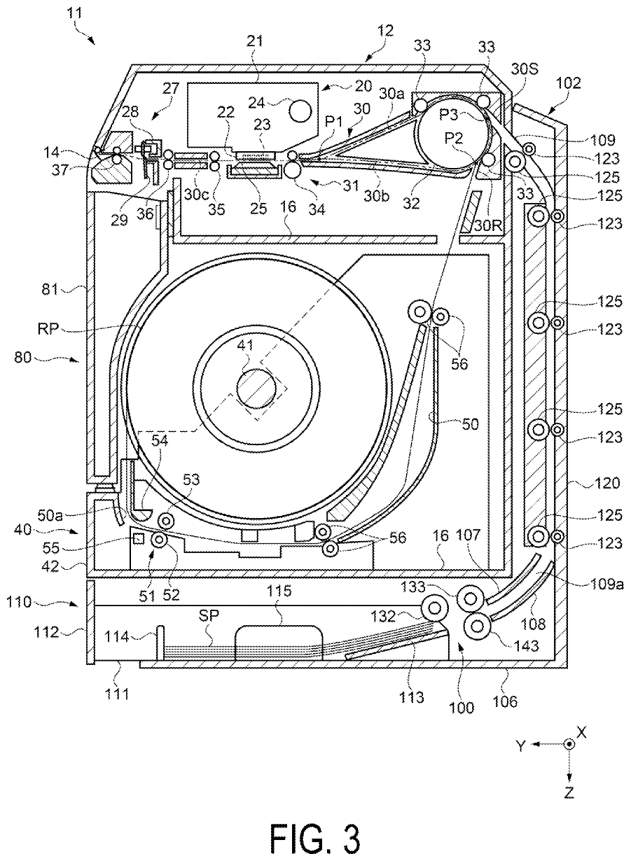

As illustrated in FIG. 3, the roll paper accommodating unit 40 is provided below the recording unit 20 in the housing 12. The roll paper accommodating 40 unit is supported by the body frame 16. In the roll paper accommodating unit 40, the roll paper RP is rotatably supported by the support shaft 41 disposed along the X axis. That is, the roll paper RP, with the support shaft 41, is rotatably supported by the roll paper accommodating unit 40, with the support shaft 41 serving as the center of rotation. The roll paper accommodating unit 40 is provided with a roll paper transporting path 50 that transports the roll paper RP unwound from the rolled state toward the roll paper supply path 30R.

In the roll paper transporting path 50, the roll paper RP is unwound and drawn downward from the front side of the roll paper RP body supported by the support shaft 41. Then, the drawn roll paper RP is bent rearward, extends around the lower side and the rear side of the roll paper RP main body, and is transported to the roll paper supply path 30R above the roll paper RP main body.

The roll paper transport path 50 has a bent portion 50a, bending at substantially a right angle, on an obliquely lower side of the roll paper RP body. A decurl mechanism 51 is provided immediately downstream of the bent portion 50a of the roll paper transport path 50. The decurl mechanism 51 corrects the curl of the roll paper RP.

The decurl mechanism 51 includes a first decurl roller 52, a second decurl roller 53, a fixed curved surface portion 54, and a moving device 55 that moves the first decurl roller 52. The roll paper RP is transported downstream through the part between the first decurl roller 52 and the fixed curved surface 54, and the part between the first decurl 52 and the second decurl roller 53.

In the roll paper transport path 50, a plurality of roll paper transport roller pairs 56 that apply a transport force to the roll paper RP are provided downstream of the decurl mechanism 51. When the roll paper transport roller pair 56 is driven into rotation, the roll paper RP is transported to the roll paper supply path 30R. Note that the transport force refers to the force of transporting the medium downstream.

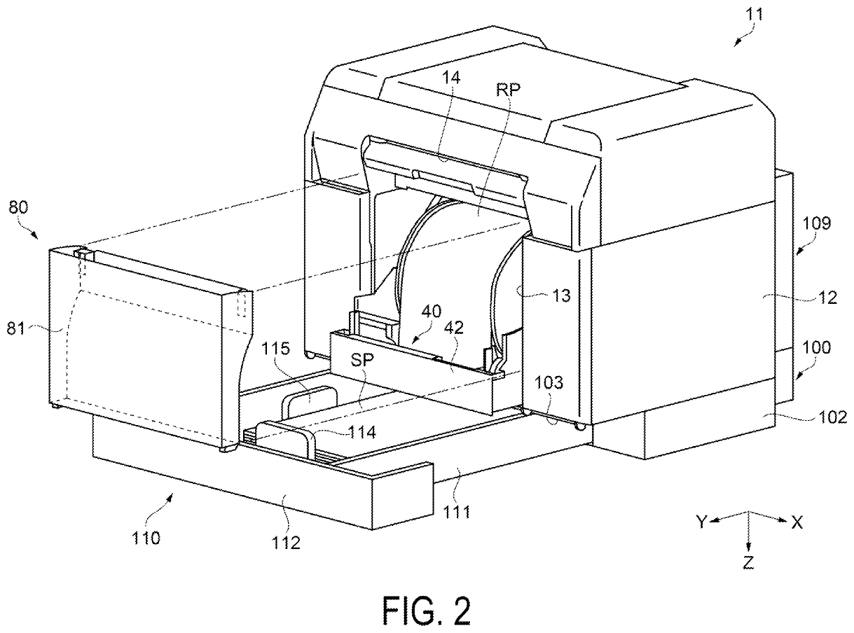

As illustrated in FIG. 2, the roll paper accommodating unit 40 is opened on the front side of the recording device 11 through an opening 13 formed in the front face of the housing 12 when the roll paper RP is accommodated or replaced. The roll paper accommodating unit 40 is movable with respect to the main body frame 16 (not illustrated) so as to be withdrawn forward from the recording device 11.

The cutting waste accommodating unit 80 is disposed in front of the roll paper accommodating unit 40, and is detachably attached to the main body frame 16. The front plate part 42 of the roll paper accommodating unit 40 of drawn type is exposed on the lower side of the cutting waste accommodating unit 80. The cutting waste accommodating unit 80 has an outer wall 81 that covers the opening 13 when attached to the housing 12.

### 2. Medium Supply Device

As illustrated in FIGS. 2 and 3, the medium supply device 100 and the transport path 109 are accommodated in a housing 102 having a substantially L-shape in side view from the -X direction. The housing 102 includes a feed frame 106 that supports each part of the medium supply device 100 and the transport path 109. A transport path 109 is provided downstream of the medium supply device 100.

The medium supply device 100 includes a single sheet paper accommodating unit 110 which is a loading unit, a feeding roller 132, a separation roller 133, and a retard roller 143. The feeding roller 132 feeds the single sheet paper SP by rotating in contact with the upper surface of the upper-most single sheet paper SP placed in the single sheet paper accommodating unit 110.

The separation roller 133 and the retard roller 143 are disposed downstream of the feeding roller 132. The transport path 109 including single sheet paper driving rollers 123 and 125 which are transport rollers, is disposed downstream of the separation roller 133 and the retard roller 143. A single sheet paper driving rollers 123, 125 are provided as one pair, and a plurality of the pairs are provided.

The single sheet paper SP loaded in the single sheet paper accommodating unit 110 is transported toward the single sheet paper supply path 30S by the single sheet paper drive rollers 123 and 125. The single sheet paper accommodating unit 110 is positioned below the roll paper accommodating unit 40, and the transport path 109 is located rearward, in the front-rear direction, of the roll paper accommodating unit 40.

The single sheet paper accommodating unit 110 includes, at the front surface, a front plate portion 112 that forms a part of the housing 102. The single sheet paper accommodating unit 110 has a box-like tray 111 in which the single sheet paper SP is accommodated. The tray 111 includes a pair of edge guides 115, a stopper 114, and a hopper 113. The pair of edge guides 115 positions the single sheet SP in the width direction. The stopper 114 positions the single sheet paper SP in the front-rear direction. The hopper 113 biases the downstream end portion of the single sheet paper SP accommodated in the tray 111 toward the feeding roller 132.

The single sheet paper accommodating unit 110 is supported by the feed frame 106. The single sheet paper accommodating unit 110 is opened on the front side of the recording device 11 through an opening 103 formed in the housing 102 when the single sheet paper SP is accommodated. The single sheet paper accommodating unit 110 is movable with respect to the feed frame 106 so as to be drawn forward of the recording device 11.

The medium feeding device 100 includes a feeding roller 132 that transports the single sheet paper SP, the retard roller 143, and the separation roller 133.

The feeding roller 132 is located above the downstream end portion of the single sheet paper SP accommodated in the single sheet paper accommodating unit 110. The feeding roller 132 rotates in contact with the upper surface of the top single sheet paper SP of the stacked single sheet paper SP. As a result, the top single sheet paper SP is removed and fed. The retard roller 143 and the separation roller 133 downstream of the feeding roller 132 are provided facing in the vertical direction. The retard roller 143 and the separation roller 133 rotate in the state of sandwiching the single sheet paper SP fed from the single sheet paper accommodating unit 110 by the feeding roller 132. In this way, the single sheet SP is fed toward the transport path 109.

The separation roller 133 and the feeding roller 132 contact the same upper surface of the single sheet paper. The retard roller 143 contacts the lower surface opposite the upper surface. The retard roller 143 is located below the separation roller 133. The retard roller 143 is pressed toward the separation roller 133 and rotates in association with the rotation of the separation roller 133. The retard roller 143 has a coefficient of friction for the single sheet SP larger than the separation roller 133. Then, the separation roller 133 and the retard roller 143 separate and transport the single sheet paper SP one by one using the difference in the coefficient of friction.

The transport path 109 includes a bent transport path 109a that bends upward the single sheet paper SP transported rearward from the single sheet paper accommodating unit 110. The bent transport path 109a is provided between the first transport path member 107 and the second transport path member 108. The first transport path member 107 and the second transport path member 108 are disposed facing each other. The second transport path member 108 supports the lower surface of the single sheet paper SP.

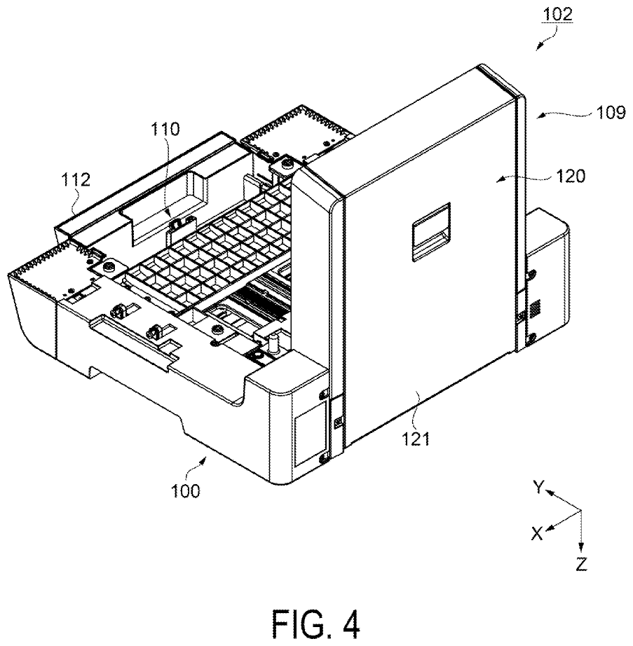

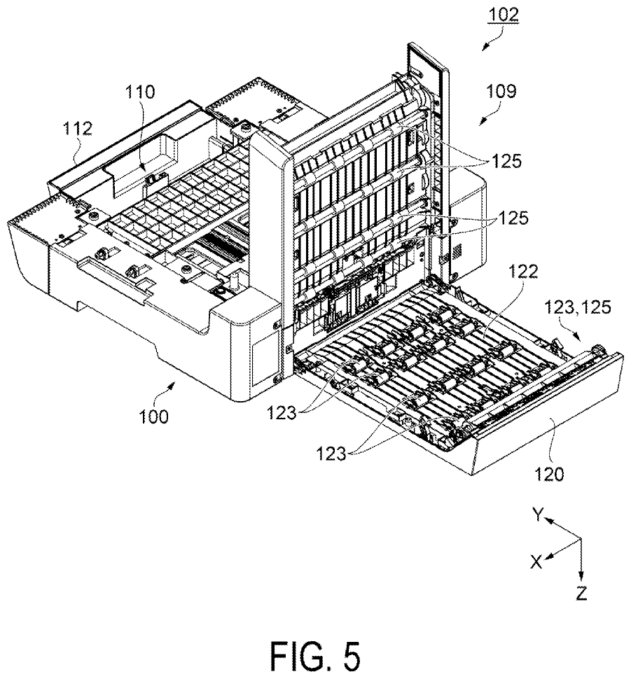

As illustrated in FIGS. 4 and 5, the medium supply device 100 includes a second cover 120 covering the rear surface of the housing 102. Although not shown, the second cover 120 has a rotation shaft along the X axis at the lower end, and is rotatably coupled to the lower part of the housing 102 by the rotation shaft. In the state in which the second cover 120 is closed, the outer wall 121 of the second cover 120 forms part of the housing 102, and the transport path 109 is configured along the inner wall 122 of the second cover 120.

In the state in which the second cover 120 is open, the transport path 109 is open. A plurality of the single sheet paper driving rollers 123, and the single sheet paper driving rollers 125 are disposed in the transport path 109 along the inner wall 122. One single sheet paper driving roller 123 corresponds to each of the plurality of single sheet paper driving rollers 125, and the single sheet paper driving roller 125 and the single sheet paper driving roller 123 form a pair. In the present embodiment, five pairs of the single sheet paper driving rollers 123, and 125 are disposed in the transport path 109.

The single sheet paper driving roller 125 applies a transport force to the single sheet paper SP. The single sheet paper driving roller 123 rotates driven by the single sheet paper driving roller 125 with the single sheet paper SP therebetween. The pair of the single sheet paper drive roller 123 and the single sheet paper drive roller 125 is provided in the transport path 109 at appropriate intervals. The single sheet paper driving roller 125 is driven into rotation, and thus the single sheet paper SP is transported from downward to upward.

Although not illustrated, the plurality of paper driving rollers 125 include a speed increase mechanism. In the speed increase mechanism, the transport speed of the single sheet paper SP is increased toward downstream. As a result, the single sheet paper SP is transported while somewhat drawn downstream, and thus the occurrence of the medium jam can be suppressed. The speed increase mechanism, for example, is achieved by changing the ratio of the gears driven or changing the roller diameter in the plurality of single sheet paper driving rollers 125.

Specifically, in a case where the gear ratio is changed, for example, a structure is adopted in which the plurality of single sheet paper driving rollers 125 are sequentially driven by one drive source, and the ratio of the gears driven by each of the single sheet paper driving rollers 125 is set to be smaller toward downstream. Furthermore, the roller diameter of the single sheet paper driving roller 125 is reduced toward the downstream side.

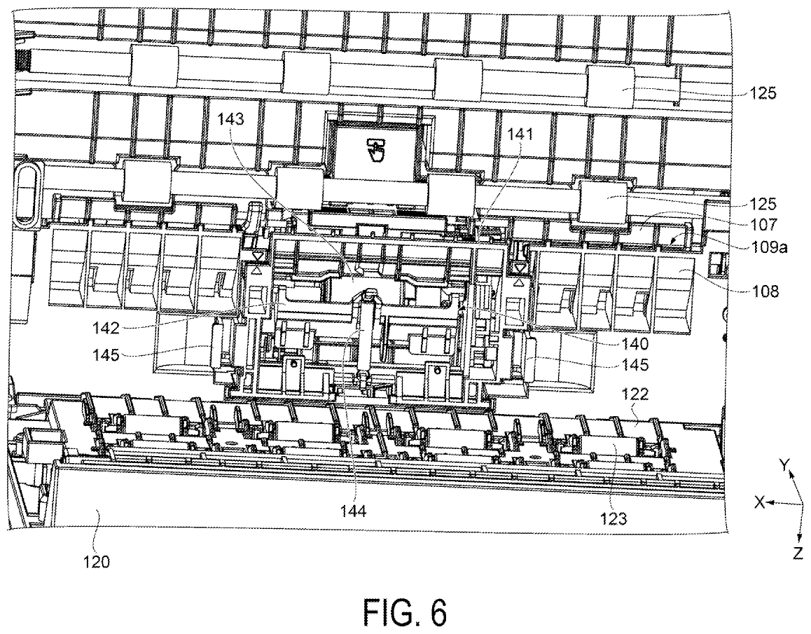

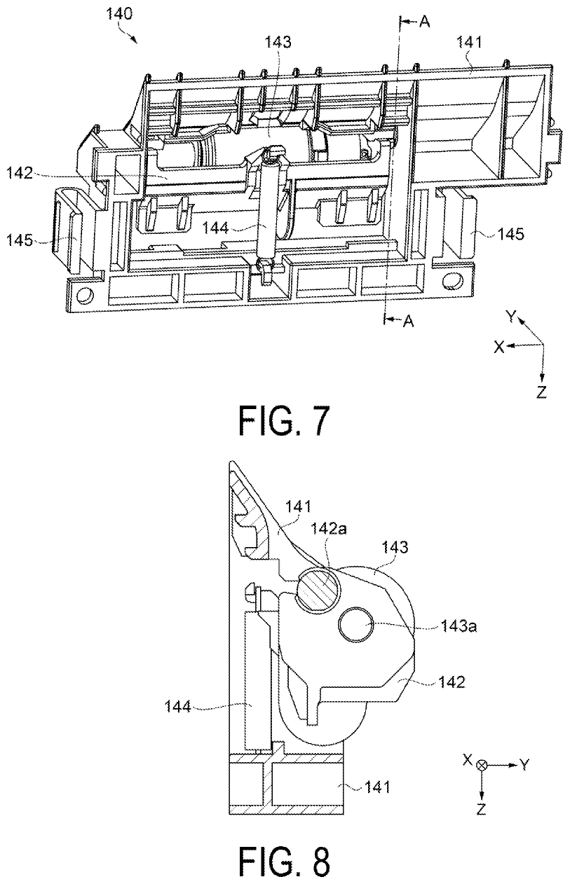

As illustrated in FIGS. 6 to 8, the second roller unit 140 is detachably attached to the second transport path member 108. The second roller unit 140 includes a retard roller 143 and a first cover 141 as a second holding part that holds the retard roller 143. The first cover 141 includes a frame portion 142 that supports the retard roller 143.

The first cover 141 is covered with the second cover 120, and is opened on the rear side of the housing 102 in the state in which the second cover 120 is open. When the second roller unit 140 is attached to the second transport path member 108, the first cover 141 is integrated with the second transport path member 108 to form the bent transport path 109a. An engagement portion 145 that engages with the second transport path member 108 is provided on both sides, in the direction along the X-axis, of the first cover 141. When the engagement portion 145 is disengaged, the first cover 141 is placed in an open state.

In the present embodiment, the state in which the first cover 141 is open is also a state in which the first cover 141 holding the retard roller 143 is removed from the second transport path member 108. Specifically, the second roller unit 140 is removed from the second transport path member 108 in the state in which the engagement portion 145 is disengaged. This allows the first cover 141 and the retard roller 143 included in the second roller unit 140 to be removed from the second transport path member 108.

The frame portion 142 is a frame-shaped member that is open upward in a state of being attached to the second transport path member 108. The frame portion 142 rotatably supports both ends, along the X-axis, of the rotation shaft 143a of the retard roller 143. The frame portion 142 has a rotating shaft 142a along the X-axis. Both ends of the rotating shaft 142a are rotatably retained by the first cover 141.

Also, the frame portion 142 is coupled to the first cover 141 via a biasing member 144 that biases downward. In side view from the -X direction, the rotation shaft 143a of the retard roller 143 is positioned further in the +Y direction than the rotating shaft 142a of the frame portion 142, and the coupling position of the biasing member 144 is positioned further in the −Y direction than the rotating shaft 142a of the frame portion 142. Thus, the retard roller 143 is pressed toward the separation roller 133 above the retard roller 143 in a state in which the first cover 141 is closed.

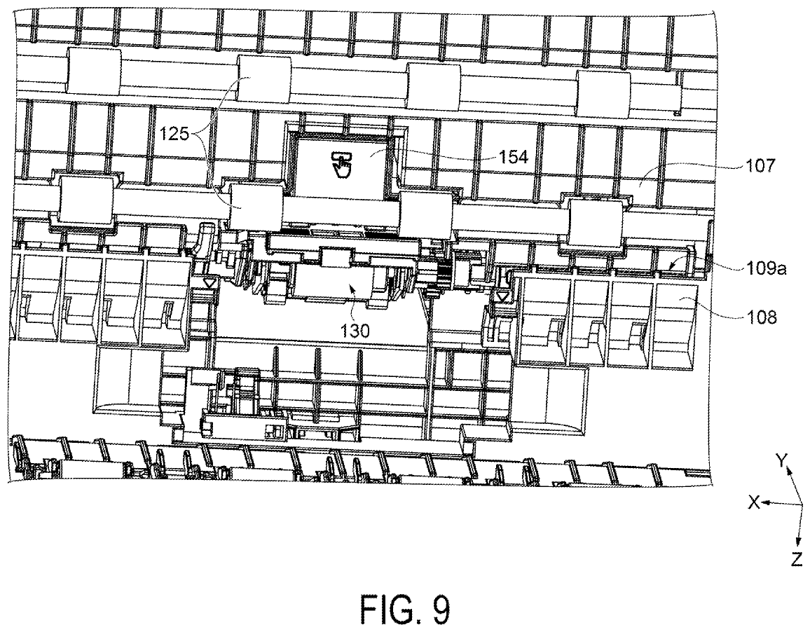

As illustrated in FIG. 9, the first roller unit 130 is detachably attached to the first transport path member 107. Operating the operation unit 154 provided at the first transport path member 107 enables removal of the first roller unit 130. The operation unit 154 is arranged above the first roller unit 130 of the first transport path member 107. The attachment and detachment of the first roller unit 130 will be described later.

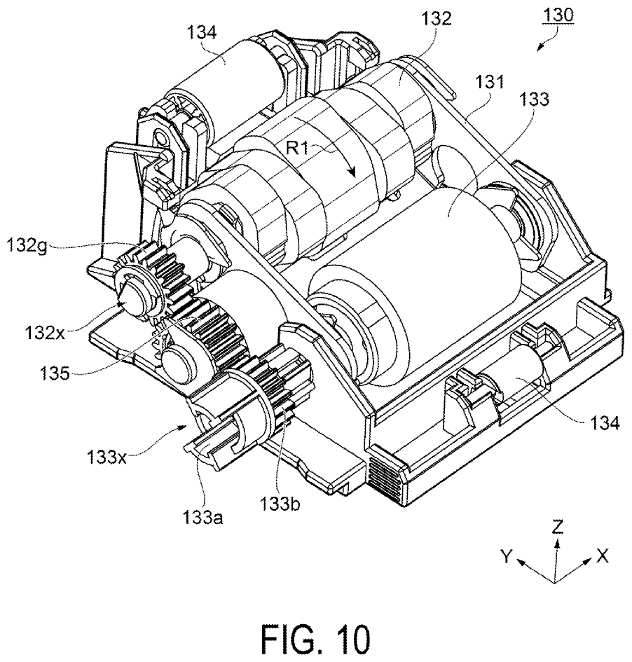

As illustrated in FIG. 10, the first roller unit 130 includes a feeding roller 132, a separation roller 133, and a first holding portion 131. The first holding portion 131 holds the feeding roller 132 and the separation roller 133.

The first holding portion 131 is a frame-shaped member that is open downward in a state of being attached to the first transport path member 107. The first holding portion 131 rotatably holds both ends, along the X-axis, of the rotation shaft 132x of the feeding roller 132. The rotation shaft 132x includes a second gear 132g that transfers a driving force to the feeding roller 132.

The first holding portion 131 rotatably holds both ends, along the X-axis, of the rotation shaft 132x of the feeding roller 132. The rotation shaft 133x includes a third gear 133b that transmits a driving force to the separation roller 133. The separation roller 133 is arranged in the −Y direction with respect to the feeding roller 132. In the present embodiment, a configuration is illustrated in which the first roller unit 130 includes two auxiliary rollers 134 in front of the feeding roller 132 and behind the separation roller 133.

The first holding portion 131 includes a first gear 135 that meshes with the second gear 132g and the third gear 133b. The rotation center of the third gear 133b is provided with a recessed portion 133a that receives a driving force for rotating the feeding roller 132 and the separation roller 133. Rotation of the third gear 133b drives the separation roller 133 into rotation. Additionally, the rotation of the third gear 133b is transmitted to the second gear 132g via the first gear 135, thereby driving, through the second gear 132g and the rotation shaft 132x, the feeding roller 132 into rotation.

When the single sheet paper SP is fed, the feeding roller 132 rotates forward in the rotational direction R1. As the feeding roller 132 rotates in the rotational direction R1, a feed force is applied to the single sheet paper SP placed on the single sheet paper accommodating unit 110 described above, and the single sheet paper SP is fed downstream. Here, the feed force refers to a force that sends the single sheet paper SP downstream from the single sheet paper accommodating unit 110.

The separation roller 133 is also driven to rotate via the third gear 133b in association with the forward rotation of the feeding roller 132. An engagement portion (not illustrated) is provided at the rear end in the −Y direction of the first holding portion 131. The engagement portion engages with the first transport path member 107 when the first roller unit 130 is mounted on the first transport path member 107.

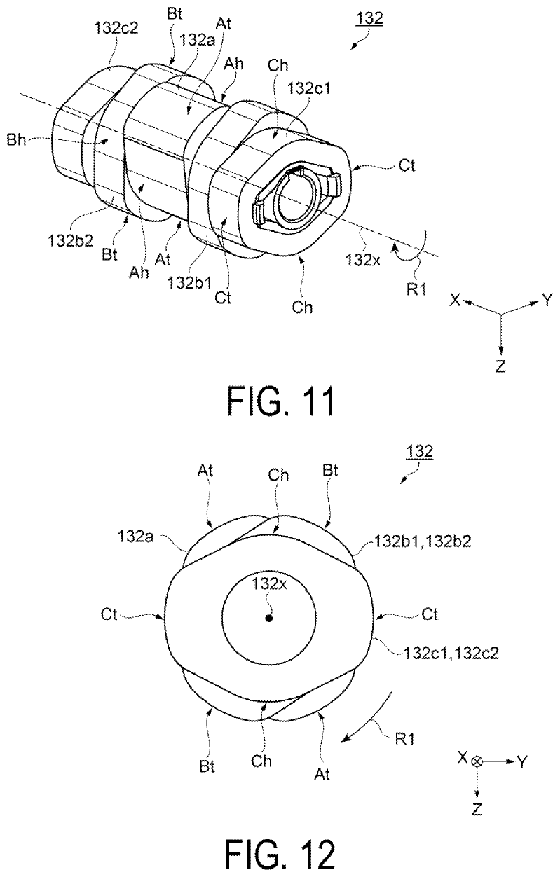

As shown in FIG. 11, the feeding roller 132 is constituted by a plurality of divided feeding rollers 132c1, 132b1, 132a, 132b2, 132c2 arranged in this order along the +X direction, which is the first direction. The feeding roller 132, in the rotational direction R1, has contact portions At, Bt, and Ct that come into contact with the single sheet paper SP (not illustrated) and a non-contact portions Ah, Bh, Ch, that do not contact the single sheet paper SP. The contact portion At and the non-contact portion Ah are included in the divided feeding roller 132a. The contact portion Bt and the non-contact portion Bh are included in each of the divided feeding rollers 132b1, 132b2. The contact portion Ct and the non-contact portion Ch are included in each of the divided feeding rollers 132c1, 132c2.

The contact portions At, Bt, and Ct are portions protruding relatively to the non-contact portions Ah, Bh, and Ch in the radial direction around the rotational axis 132x, in side view from the -X direction. As a result, as the feeding roller 132 rotates around the rotation shaft 132x, the contact portions At, Bt, and Ct contact the single sheet paper SP, and the feed force is applied to the single sheet paper SP. The contact portions At, Bt, Ct, and the non-contact portions Ah, Bh, and Ch are made from a material having elasticity such as rubber, for example.

Note that in FIG. 11, for convenience of illustration, the contact portion Bt and the non-contact portion Bh of the divided feeding roller 132b1 and the contact portion Ct and the non-contact portion Ch of the divided feeding roller 132c2 are not illustrated.

Contact portions Ah, Bh, Ch, which are a plurality of contact portions, and non-contact portions Ah, Bh, and Ch, which are a plurality of non-contact portions ares provided along the X direction, which is the extending direction of a rotation axis of the rotary shaft 132x of the feeding roller 132. The contact portions adjacent to each other in the X-direction are out of phase in the rotational direction R1.

Specifically, the above-mentioned adjacent contact portions are the contact portion At and the contact portion Bt, and the contact portion Bt and the contact portion Ct. In side view from the −X direction, the contact portion At and the contact portion Bt, and the contact portion Bt and the contact portion Ct are disposed out of phase, respectively, by an angle of approximately 60 degrees. Note that the contact portion At and the contact portion Ct are not adjacent in the X direction, but are disposed out of phase by an angle of approximately 60 degrees in side view from the −X direction. As a result, the contact portions At, Bt, and Ct each individually contact the single sheet paper SP in association with the rotation of the feeding roller 132 without simultaneously contacting the single sheet paper SP.

Note that the contact portion Bt of the divided feeding roller 132b1 and the contact portion Bt of the divided feeding roller 132b2 have the same phase in the rotational direction R1. Note that the contact portion Ct of the divided feeding roller 132c1 and the contact portion Bt of the divided feeding roller 132b2 have the same phase in the rotational direction R1.

Since the contact portions At, Bt, and Ct are disposed out of phase in the rotational direction R1, any of the plurality of contact portions At, Bt, and Ct disposed along the X direction is brought into contact with the single sheet paper SP while the feeding roller 132 makes one rotation, and applies the feed force to the sheet paper SP. This allows the plurality of contact portions At, Bt, and Ct to alternately applies the feed force to the single sheet paper SP which can reduce the variation in feed force.

The feeding roller 132 is obtained by assembling each of members that are divided feeding rollers 132a, 132b1, 132b2, 132c1, and 132c2. Therefore, the plurality of contact portions At, Bt, and Ct along the X direction are easily formed, and the feeding roller 132 can be easily manufactured. In addition, the arrangement change and the phase adjustment can be made for the plurality of divided feeding rollers 132a, 132b1, 132b2, 132c1, and 132c2.

As shown in FIG. 12, the divided feeding roller 132a includes two contact portions At and two non-contact portions Ah (not shown) along the rotational direction R1. Each of the divided feeding rollers 132b, 132b2 includes two contact portions Bt and two non-contact portions Bh (not illustrated).

Each of the divided feeding rollers 132c1, 132c2 includes two contact portions Ct and two non-contact portions Ch. In the rotational direction R1, the contact portion At and the non-contact portion Ah, the contact portion Bt and the non-contact portion Bh, and the contact portion Ct and the non-contact portion Ch are alternately disposed respectively.

Thus, while the feeding roller 132 makes one revolution, each of the contact portions At, Bt, and Ct comes into contact with the single sheet SP twice. Therefore, a feed force can be efficiently applied to the sheet paper SP with a small number of divided feeding rollers.

In side view from the −X direction, the contact portions At, Bt, and Ct are out of phase by approximately 60° in the rotational direction R1. The contact portion At and the contact portion Bt, the contact portion Bt and the contact portion Ct, and the contact portion Ct and the contact portion At respectively include a gap therebetween in the rotational direction R1. In contrast, the sheet paper SP is pressed by the hopper 113 described above against the feeding roller 132 when feeding. In addition, the contact portions At, Bt, and Ct of the feeding rollers 132 are formed by elastic members, and thus easily deformed by pressing. As a result, even with the gap described above, the feeding roller 132 is brought into contact with the single sheet paper SP, thereby applying the feed force constantly. In addition, the presence of the gap can suppress the variation in the state of the feed force applied to the medium, between the case where both of adjacent contact portions At, Bt come into contact with the single sheet paper SP, and the case where the contact portions At, Bt are each brought into contact independently.

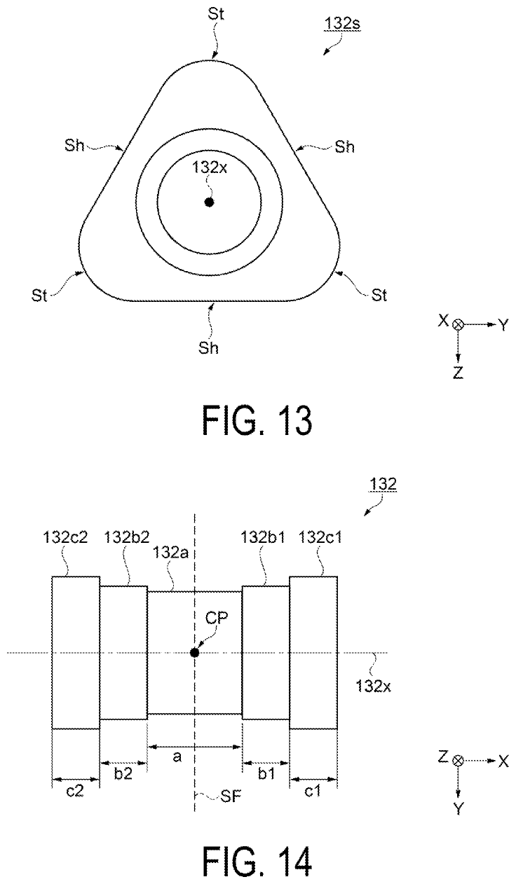

The side surface shape of the divided feeding rollers 132a, 132b1, 132b2, 132c1, and 132c2 is not limited to the above-described form. The side surface shape may be, for example, an elliptical shape or a cam shape with one contact portion. Further, as another form of the divided feeding roller 132a, the divided feeding roller 132s of FIG. 13 can be illustrated. The divided feeding roller 132s has three contact portions St and three non-contact portions Sh, and in side view from the −X direction, the contact portions St and the non-contact portions Sh are alternately disposed. A feeding roller 132 including the plurality of divided feeding rollers 132s may be used.

In this manner, in the divided feeding rollers 132a, 132b1, 132b2, 132c1, and 132c2, the number of contact portions and the non-contact portions is not limited to the above. Note that the feeding roller 132 is not necessarily made up of five divided feeding rollers 132a, 132b1, 132b2, 132c1, and 132c2. Further, the feeding roller 132 may be integrally formed as long as it includes the contact portions At, Bt, Ct, and non-contact portions Ah, Bh, and Ch described above.

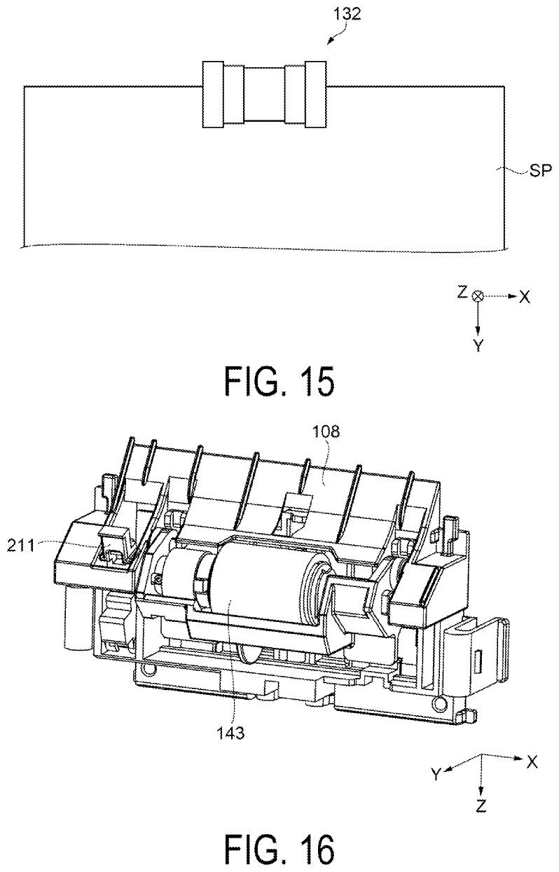

As illustrated in FIGS. 11, and 14, the feeding roller 132 includes a center position CP in the X direction of the feeding roller 132, and the plurality of contact portions At, Bt, and Ct are disposed plane symmetrically with respect to the surface SF orthogonal to the X direction. Also, as illustrated in FIG. 15, the feeding roller 132 is disposed at a central portion in the X direction and the edge portion in the −Y direction of the single sheet paper SP placed on the single sheet paper accommodating unit 110 (not illustrated) in the medium feeding device 100. This makes it possible to reduce the variation in the feed force applied to the single sheet paper SP in the X-direction to suppress the occurrence of skew transporting.

Referring back to FIGS. 11 and 14, the feeding roller 132 has the contact portion At as the first contact portion provided at the center position CP, and a set of the contact portions Bt as a set of the second contact portions on both outer sides of the contact portion At. In addition, a set of the contact portions Ct, as the second set of the second contact portions, are also provided on both outer sides of the contact portions Bt. The width of the contact portion At in the X direction, that is, the width of the divided feeding roller 132a, is equal to the sum of the widths in the X direction of the set of contact portions Bt, that is, the sum of the width b1 of the divided feeding roller 132b1 and the width b2 of the divided feeding roller 132b2. The width a of the divided feeding roller 132a, is equal to the sum of the widths in the X direction of the set of contact portions Ct, that is, the sum of the width c1 of the divided feeding roller 132c1 and the width c2 of the divided feeding roller 132c2.

In this way, the contact area of the contact portions At, the total contact area of the set of contact portions Bt and the total contact area of the set of contact portions Ct, with the single sheet paper SP, are made equal. This makes, the feed force by the contact portion At, the feed force by the set of contact portions Bt, and the feed force by the set of contact portions Ct equal, which can reduce the variation in the feed force in the feeding direction. Note that the set of second contact portions provided outside the contact portion At, which is the first contact portion, is not limited to the two sets described above. At least one set of the second contact portions may be sufficient.

As illustrated in FIG. 2, the single sheet paper accommodating unit 110 of the recording device 11 can be drawn in the +Y direction together with the tray 111. With the tray 111 drawn, the single sheet paper accommodating unit 110 can be replenished with single sheet paper SP.

As illustrated in FIG. 16, the recording device 11 includes a paper return lever 211. The paper return lever 211 is not illustrated, but has a function of returning the single sheet paper SP to the single sheet paper accommodating unit 110. The paper return lever 211 and the configuration described below have a function of returning the single sheet paper SP remaining on the second transport pathway member 108 to the single sheet paper accommodating unit 110 when the single sheet paper accommodating unit 110 is drawn forward and opened.

The paper return lever 211 is arranged in the −X direction of the retard roller 143. A cutout is provided in the second transport path member 108 corresponding to the paper return lever 211.

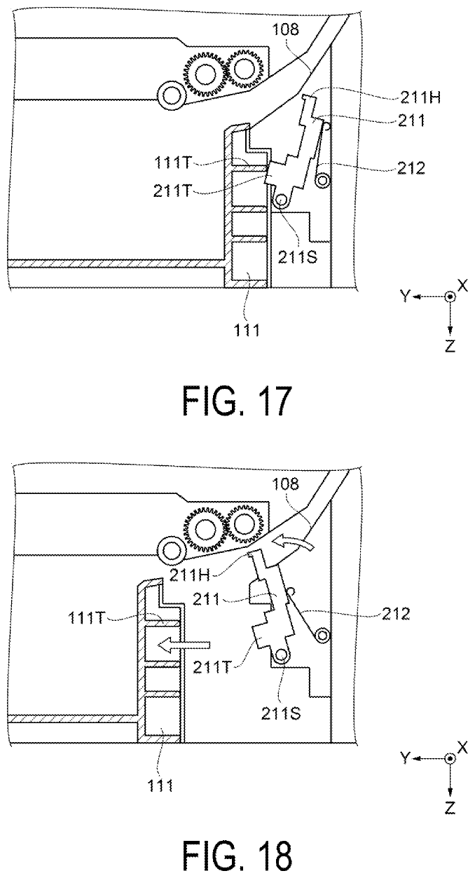

As shown in FIG. 17, the paper return lever 211 includes an distal end portion 211H on the upper side, an abutting portion 211T, and a fulcrum 211S on the lower side. The paper return lever 211 is rotatably supported by the feed frame 106 (not illustrated) at a fulcrum portion 211S that is a rotational axis along the X-axis. The paper return lever 211 operates so that the distal end portion 211H moving counterclockwise in an arc with the fulcrum portion 211S as the center of rotation, in side view from the +X direction.

A torsion spring 212 is coupled to the paper return lever 211. The torsion spring 212 biases the paper return lever 211 generally in +Y direction. When the tray 111 is set in the recording device 11, the protrusion 111T of the tray 111 contacts the contact portion 211T of the paper return lever 211, and the paper return lever 211 is biased in the −Y direction. At this time, the bias by the protrusion 111T overcomes the bias by the torsion spring 212, and thus the paper return lever 211 is tilted toward the −Y direction.

As illustrated in FIG. 18, when the tray 111 is drawn and moved in the +Y direction, the protrusion 111T and the contact portion 211T are separated. Thus, the bias of the torsion spring 212 raises the paper return lever 211 toward +Y direction. As a result, the distal end portion 211H moves counterclockwise in an arc protruding upward of the second transport pathway member 108. At this time, when the single sheet paper SP is present in the second transport pathway member 108, the single sheet paper SP is returned to the single sheet paper accommodating unit 110 (not illustrated) of the tray 111 by the movement of the distal end portion 211H. Note that FIG. 18, illustrates a state in which the tray 111 is drawn in the +Y direction further than the position where the single sheet SP is returned.

As a result, the single sheet paper SP remaining in the second transport pathway member 108 is returned to the single sheet paper accommodating unit 110 in association with the drawing of the tray 111. Therefore, the jam or the breakage of the single sheet paper SP around the second transport pathway member 108 can be prevented by inserting and removing the tray 111.

The medium supply device 100 has a retraction function of the feeding roller 132. By the retraction function, as the transport of the single sheet paper SP by the single sheet paper driving rollers 123, 125, which are the transport rollers, is started in association with the feed of the single sheet paper SP by the feeding roller 132, the feeding roller 132 is displaced from a contact state with the single sheet paper SP to a separate state from the single sheet paper SP.

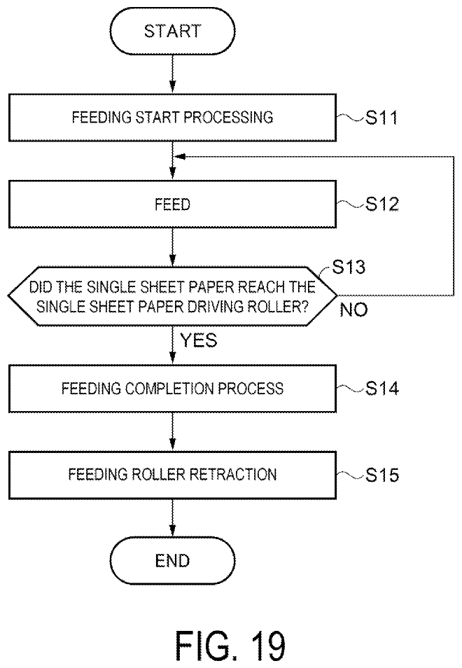

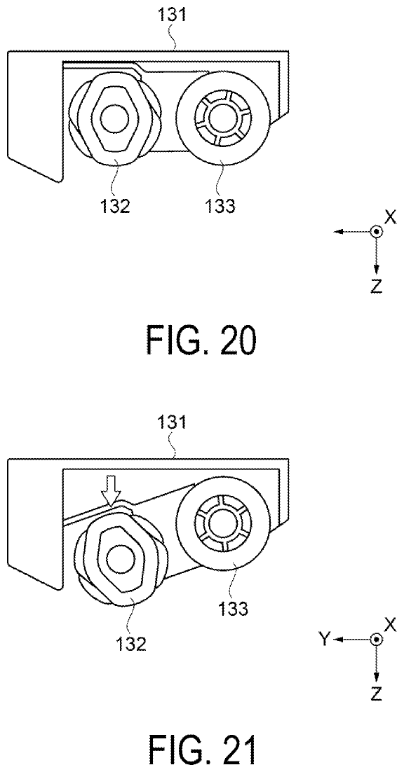

As illustrated in FIG. 19, the retraction function of the feeding roller 132 includes step S11 to step S15. The feeding roller 132 comes into contact with the single sheet paper SP only while the single sheet paper SP is fed, and otherwise is separated and retracted upward corresponding to −Z direction. The arrangement of the feeding roller 132 in the retracted state is illustrated in FIG. 20. The arrangement of the feeding roller 132 in the feeding state is illustrated in FIG. 20.

In step S11, feeding of the single sheet paper SP is started by a printing instruction from, for example, an information device. The feeding of the single sheet paper SP may be started on the condition that the sensor detects the presence of the single sheet paper SP, and the single sheet paper SP is in the single sheet paper accommodating unit 110. Then, the process proceeds to step S12.

In step S12, the single sheet paper SP is fed. When the driving force for positive rotation is transmitted to the feeding roller 132 and the separation roller 133 by the printing instruction described above, the feeding roller 132 transitions from the retracted state of FIG. 20 to the feeding state of FIG. 21. In other words, the feeding roller 132 moves in +Z direction and comes into contact with the single sheet paper SP, and rotates forward in the rotational direction R1 described above. At this time, the separation roller 133 and the single sheet paper driving roller 125 (not illustrated) also rotate forward in the same direction. In this way, the single sheet SP is fed downstream from the single sheet paper accommodating unit 110. Then, the process proceeds to step S13.

In step S13, it is determined whether the single sheet paper SP has reached the single sheet paper driving roller 125 on the most upstream side of the transport path 109 described above. The arrival of the single sheet paper SP is detected by a sensor provided in the transport path 109. When the single sheet paper SP arrives, the process proceeds to step S14. If the single sheet paper SP does not reach, then the process returns to step S12 and the feeding is continued.

In step S14, the feeding completion processing is performed. Specifically, the transmission of the driving force to the feeding roller 132 and the separation roller 133 is stopped. In contrast, the single sheet paper driving roller 125 continues to rotate forward, and thus continues to transport the single sheet paper SP downstream. Then, the process proceeds to step S15.

In step S15, the retraction of the feeding roller 132 is performed. In particular, the driving force for reverse rotation is transmitted to the feeding roller 132 and the separation roller 133. The separation roller 133 is not driven by the driving force for reverse rotation. A torque limiter that is attached in the feeding roller 132 is activated by the driving force for reverse rotation. As a result, the feeding roller 132 moves clockwise, in side view from the +X direction, with the rotational axis 133x (not illustrated) as the rotational axis of the separation roller 133. As a result, the feeding roller 132 is retracted moving generally upward and is separated from the single sheet paper SP. At this time, the single sheet paper driving roller 125 continues to rotate.

Note that the drive source of the feeding roller 132 and the separation roller 133 and the drive source of the single sheet paper driving roller 125 may be used together. In this case, a dual one way mechanism that always rotates forward regardless of the direction of rotation of the drive source is employed as the single sheet paper driving roller 125. An electric motor or the like is used for the drive source.

In this way, while the feeding roller 132 contacts the single sheet paper SP to apply a feed force thereto as necessary, when the feed force is unnecessary, the feeding roller 132 does not contact the single sheet paper SP. As a result, the time of contact between the single sheet paper SP and the feeding roller 132 is reduced, and thus the occurrence of roller marks by the feeding roller 132 can be further suppressed.

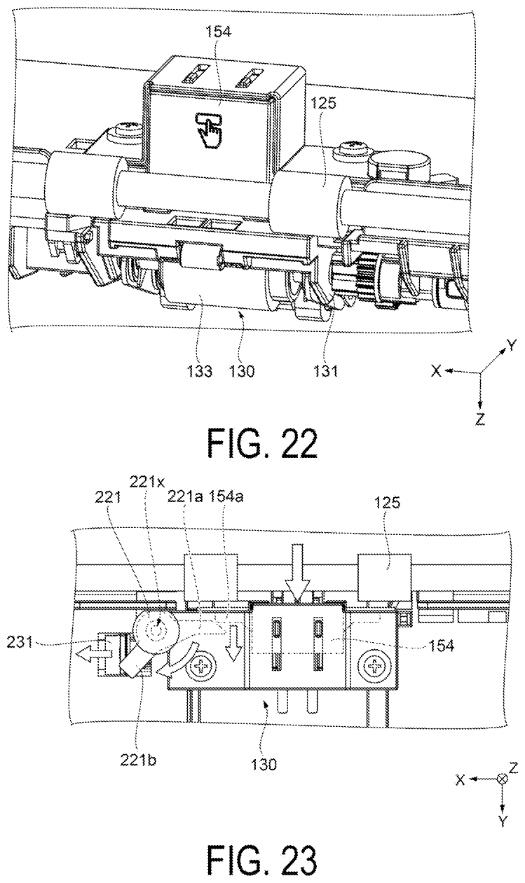

As illustrated in FIG. 22, the operation unit 154 is provided above the first roller unit 130. The operation unit 154 is a substantially rectangular push button in side view from −Y direction. The operation unit 154 is included in the attachment and detachment mechanism for the first roller unit 130 described later.

As illustrated in FIG. 23, the attachment and detachment mechanism of the first roller unit 130 includes an operation unit 154, a lever unit 221, and a slide unit 231. Although not illustrated, the operation unit 154 is supported reciprocably, in the direction along Y axis, by the feed frame 106 via the spring member and the guide portion. The spring member, after the operation unit 154 is pressed against the spring member, biases the operation unit 154 back to the position thereof before being pressed. The guide portion described above guides movement, along the Y-axis, of the operation unit 154. The operation unit 154 is capable of moving, in a direction along Y axis, relative to the feed frame 106 by a distance corresponding to the stroke of the push button described above. The operation unit 154 has a protruding portion 154a protruding in +X direction.

The lever unit 221 is supported, by a feed frame 106 (not illustrated), movably around the rotational axis 221x by approximately 45°. The lever unit 221 includes arm portions 221a, 221b. The arm portion 221a is provided protruding in −X direction corresponding to the protruding portion 154a of the operation unit 154. The arm portion 221b is provided protruding in a substantially +X direction corresponding to the slide portion 231.

The slide portion 231 is supported movably, in the direction along the X axis, relative to the feed frame 106. The slide portion 231 is biased in −X direction by a spring member (not illustrated) . Although not illustrated, the slide portion 231 is mechanically coupled to the clutch unit that transmits the drive force to the recessed portion 133a described above from the drive source. When the slide portion 231 moves in +X direction, thus, the clutch unit is separated from the recessed portion 133a.

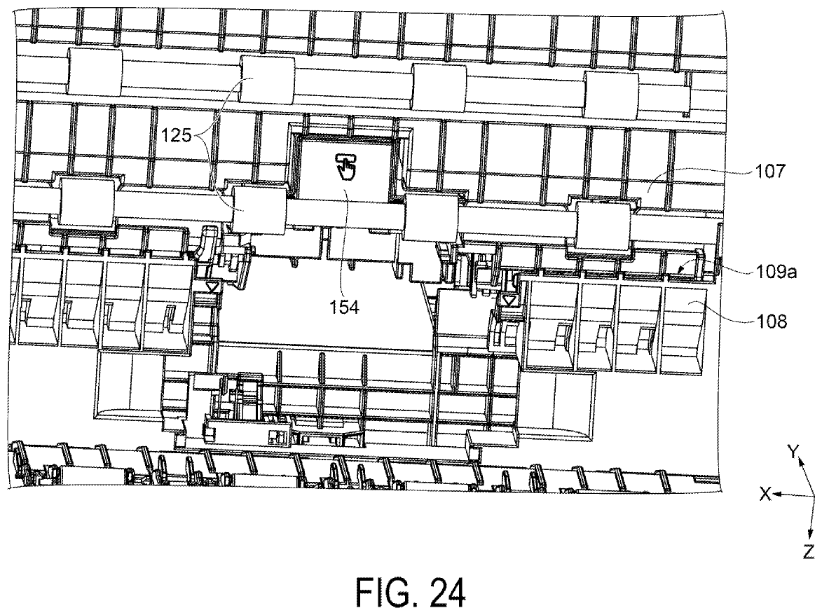

When the first roller unit 130 is removed, the operation unit 154 is pushed in +Y direction. The protruding portion 154a moves in +Y direction along with the operation unit 154. As a result, the protruding portion 154a and the arm portion 221a come into contact with each other, applying a force to the lever unit 221 in +Y direction. The force in +Y direction rotates the lever unit 221 clockwise. Rotation of the lever unit 221 cause the arm portion 221b and the slide portion 231 to come into contact with each other, and thus the slide portion 231 is pressed and moved in +X direction. Then, the clutch unit and the recessed portion 133a are separated from each other, which enables removal of the first roller unit 130. Thus, the first roller unit 130 can be removed as illustrated in FIG. 24.

Since the clutch unit is always biased toward the first roller unit 130 side, when the first roller unit 130 is attached to the clutch unit, the clutch unit and the recessed portion 133a can be fitted automatically by rotationally driving the drive source even when the clutch unit and the recessed portion 133a are imcompletely fitted. As described above, the first roller unit 130 can be removed and replaced by a simple operation.

According to the present embodiments, the following advantages can be obtained.

The occurrence of roller marks, on the single sheet paper SP as the medium, by the feeding roller 132 can be suppressed. Specifically, the feeding roller 132 includes the contact portions At, Bt, Ct, and the non-contact portions Ah, Bh, and Ch, and repeats contact and non-contact with the single sheet paper SP by rotating. Further, the plurality of contact portions At, Bt, and Ct are arranged in a state of being out of phase along the X direction in the rotational direction R1. Thus, the rotation of the feeding roller 132 causes any of the plurality of contact portions At, Bt, and Ct to come into contact with the single sheet SP, and thus start feeding the single sheet SP. Then, when the contact portion and the single sheet paper SP are separated, other contact portions come into contact with the single sheet paper SP, and proceed the feeding.

In this way, feeding of the single sheet SP is performed with the plurality of contact portions At, Bt, and Ct alternately contacting the single sheet SP repeatedly. Thus, for the second sheet of the single sheet paper SP which is otherwise likely to have the roller marks, the pressure from the feeding roller 132 is dispersed without being concentrated at both end portions in the extending direction of the rotational axis 132x of the feeding roller 132, for example. At the same time, the region to be pressed is sequentially changed to suppress occurrence of the roller marks. This makes it possible to provide a medium supply device 100 and a recording device 11 that suppress the occurrence of a roller marks by the feeding roller 132.

What is claimed is:

1. A medium supply device comprising:
a loading unit at which media are stacked and placed; and
a feeding roller configured to feed the media by rotating in contact with a top surface of the placed media, wherein
the feeding roller includes a contact portion configured to contact the media and a non-contact portion configured to not contact the media in a rotational direction, and a plurality of the contact portions and the non-contact portions are provided in a first direction that is an extending direction of a rotation axis of the feeding roller, and the contact portions adjacent to each other in the first direction are out of phase in the rotational direction.

2. The medium supply device according to claim 1, wherein
while the feeding roller makes one rotation, any of the plurality of contact portions disposed along the first direction applies a feed force to the media.

3. The medium supply device according to claim 1, wherein
the feeding roller is disposed at a central portion in the first direction of the media placed at the loading unit, and includes a center position in the first direction of the feeding roller, and a plurality of the contact portions are disposed plane symmetrically with respect to a plane orthogonal to the first direction.

4. The medium supply device according to claim 3, wherein
the feeding roller includes a first contact portion provided at the center position, and at least a set of second contact portions on both outer sides of the first contact portion, and a width in the first direction of the first contact portion is equal to the sum of the widths in the first direction of the set of the second contact portions.

5. The medium supply device according to claim 1, wherein
the feeding roller includes a plurality of divided feeding rollers disposed along the first direction, and the contact portions of the divided feeding rollers adjacent to each other in the first direction are out of phase.

6. The medium supply device according to claim 1, wherein
the feeding roller includes a plurality of the contact portions and a plurality of the non-contact portions along the rotational direction, and the contact portions and the non-contact portions are alternately disposed in the rotational direction.

7. The medium supply device according to claim 1, wherein a separation roller is disposed downstream of the feeding roller, and a transport roller is disposed downstream of the separation roller, and when the transport roller starts transporting the medium in response to the feeding roller feeding the medium, the feeding roller is displaced from a contact state with the medium to a separated state.

8. A medium supply device comprising:
a recording unit configured to perform recording on a medium;
a medium supply unit configured to supply the medium toward the recording unit; and
a transport path configured to transport the medium from the medium supply unit to the recording unit; wherein
the medium supply unit includes:
a loading unit at which the medium is placed; and
a feeding roller configured to feed the medium by rotating in contact with a top surface of the loaded medium,
the feeding roller includes a contact portion configured to contact the medium and a non-contact portion configured to not contact the medium in a rotational direction, and a plurality of the contact portions and the non-contact portions are provided in a first direction that is an extending direction of the rotation axis of the feeding roller, and the contact portions adjacent to each other in the first direction are out of phase in the rotational direction.
